(19) United States
(12) Patent Application Publication
(10) Pub. No.: US 2009/0300398 A1
(43) Pub. Date: Dec. 3, 2009

(54) CONTROL STRUCTURE FOR A POWER SUPPLY CLUSTER

(75) Inventors: Chin-Szu LEE, Taipei Hsien (TW); Chin-Sung Chen, Taipei Hsien (TW)

Correspondence Address: Muncy, Geissler, Olds & Lowe, PLLC, P.O. BOX 1364, FAIRFAX, VA, 22038-1364, US

(73) Assignee: TOPOWER COMPUTER INDUSTRIAL CO., LTD.

(21) Appl. No.: 12/127,262

(22) Filed: May 27, 2008

(51) Int. Cl. G06F 1/26

(52) U.S. Cl. 713/330

(57) ABSTRACT

A control structure for a power supply cluster which has a primary power supply and a secondary power supply that are independently linked to AC power and transform the AC power to DC power to supply electric power required by an electronic device in a computer equipment. A switch unit is provided to be linked to the primary power supply and the secondary power supply to get a start signal from the primary power supply and transfer to the secondary power supply. Electric power of the primary power supply also is transferred to the electronic device to present a first power supply status. A judgment unit also is provided to be linked to the primary power supply and the switch unit to get the start signal and defer sending a switch signal to the switch unit so that the electronic device can get electric power from the secondary power supply and present a second power supply status. Thereby the electronic device can continuously get the electric power after the primary power supply is started to improve the shortcoming of a conventional power supply cluster that is not started concurrently and results in poor system matching, and requires an additional transmission line even if concurrent start can be accomplished.

### FIELD OF THE INVENTION

The present invention relates to a control structure for a power supply cluster and particularly to a power supply cluster to provide power needed on a computer system by concurrently starting a primary power supply and a secondary power supply.

### BACKGROUND OF THE INVENTION

To meet the requirements of rapid technology progress of multimedia and the Internet, the performance power of CPU, motherboards and computer peripheral devices such as graphic interface cards also soars. As a result of power needed by computers increases greatly, hence once the computer facilities are upgraded, the original power supply also has to be upgraded to provide additional power needed. As the pace of computer upgrade is very fast, to upgrade the power specification of the power supply with upgrade of personal computers becomes a heavy cost burden to many users. One common approach to address this issue is procuring a higher capacity power supply based on the maximum power requirement by taking into account of possible upgrades in the future. However, the power supply with higher capacity is more expensive than the one with small and medium capacities. Users often are reluctant to make such a procurement because future upgrade requirements are difficult to predict. Hence another approach is adopted by procuring two or more power supplies. A power supply with a lower or medium capacity is purchased first. In the event that the personal computer is upgraded and more electric power is needed, another power supply is procured. Each power supply has an independent AC input end and a DC output end to supply DC power to computer peripheral devices (such as VGA, HDD, CPU and the like).

Japan patent publication No. 3122194 discloses a technique that has a primary power supply and a secondary power supply. The primary power supply has an input end connecting to city power and an output end to output DC power. After the primary power supply is started the output end outputs a start power to activate the secondary power supply. R.O.C. patent No. M292102 discloses another technique which has a signal synchronous unit electrically connected to a motherboard, a first power supply and a second power supply. When in use the motherboard generates a start signal which is sent to the first power supply and the second power supply through the signal synchronous unit so that the first and the second power supplies are activated concurrently to supply power to the motherboard and a video graphic card on the motherboard.

The two cited references set forth above provide two sets of power supplies to supply electric power required by the peripheral devices of the computer. But in Japan No. 3122194, the primary power supply has to be started first before activating the secondary power supply. They are not started concurrently. Hence there is a time lag between activation of the primary power supply and the secondary power supply. When the peripheral devices (such as motherboard) driven by the primary power supply are operating, the peripheral devices (such as display card, hard disk and the like) driven by the secondary power supply are not yet started and cannot be detected. Moreover, the time of power transformation or output of activation power of the primary power supply with different specifications is different, systemic matching becomes a problem. R.O.C. patent No. M292102 overcomes this problem by providing synchronous activation, but it requires an additional transmission line with a 24PIN connector to connect the motherboard, the first power supply and the second power supply. More wiring is needed in the computer host, and the installation cost is higher. Besides, cooling of the computer host also becomes another problem.

### SUMMARY OF THE INVENTION

The primary object of the present invention is to solve the aforesaid disadvantages by providing a technique to concurrently start a primary power supply and a secondary power supply and simplifying wiring of the primary power supply and the secondary power supply.

To achieve the foregoing object the present invention provides a control structure for a power supply cluster. The power supply cluster includes a primary power supply and a secondary power supply that are independently linked to AC power and transform the AC power to DC power to supply electric power required by an electronic device in a computer equipment. The control structure has a switch unit connecting to the primary power supply and the secondary power supply, and a judgment unit connecting to the primary power supply and the switch unit that has a delay time reference value. The switch unit gets a start signal showing the start status of the primary power supply and transfers to the secondary power supply to concurrently activate the secondary power supply. And the power of the primary power supply is transferred to the electronic device and a first power supply status is presented. The switch unit also gets the start signal and outputs a switch signal to the switch unit after a delay time period according to the delay time reference value. Thereby the electronic device gets the power from the secondary power supply and a second power supply status is presented. Thus the primary power supply provides power to the electronic device at the start time, and the secondary power supply also gets the start signal through the switch unit and is started concurrently with the primary power supply, and outputs power to the electronic devices to switch power supply status in order to allow the electronic device to receive the power continuously.

By means of the technique provided by the invention, many benefits can be obtained, notably:

1. The electronic device driven by the primary power supply and the electronic device driven by the secondary power supply can be matched closely.

2. Wiring in the computer host can be simplified, and the cost of installation and time also are reduced. Cooling efficiency of the electronic device in the computer host also improves.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a structural block diagram of the invention.

FIG. 2 is a schematic view of an embodiment of the structure of the invention.

FIG. 3 is a circuit diagram of the invention.

FIG. 4 is a waveform chart of the secondary power supply in a start status.

### DETAILED DESCRIPTION OF THE PREFERRED EMBODIMENT

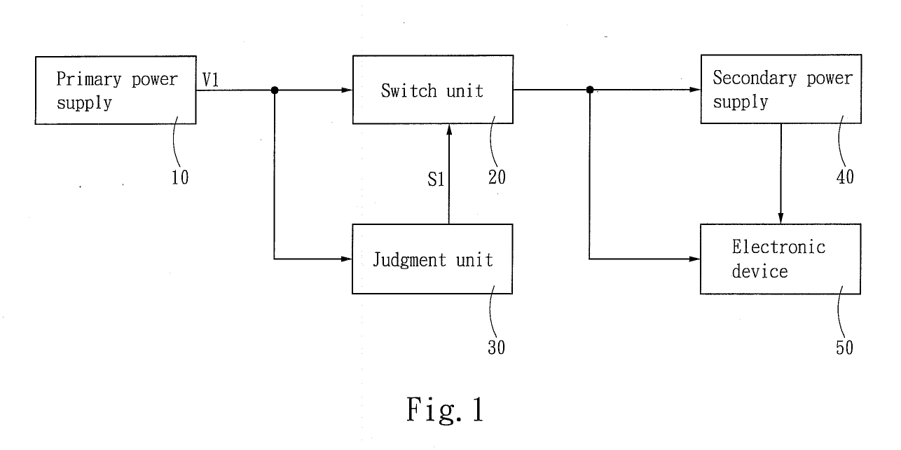

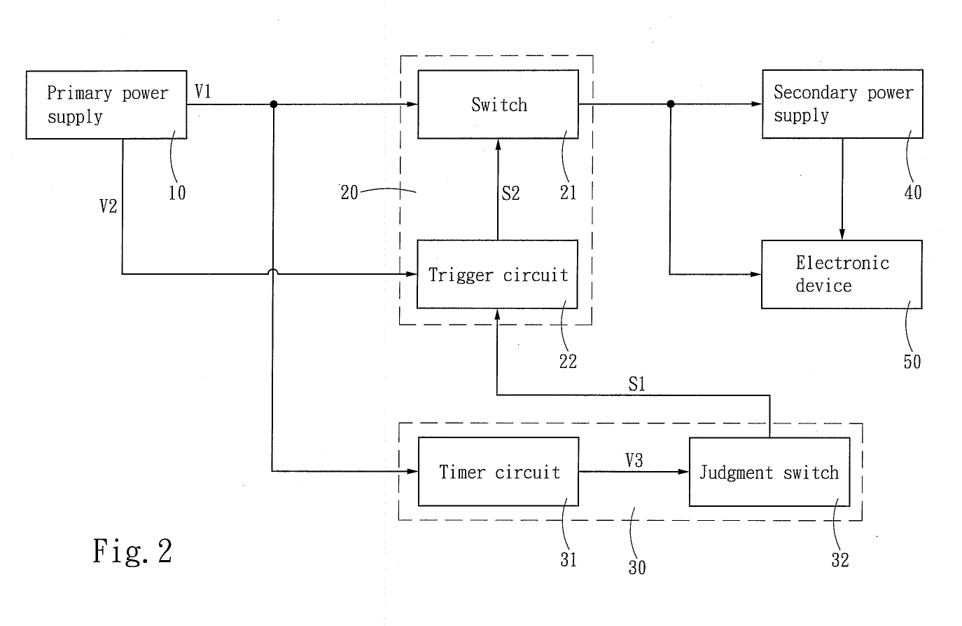

Please refer to FIG. 1 for the control structure for a power supply cluster of the invention. The power supply cluster includes a primary power supply 10 and a secondary power supply 40 that are independently linked to AC power and transform the AC power to DC power to supply electric power required by an electronic device 50 in a computer system. The control structure has a switch unit 20 connecting to the primary power supply 10 and the secondary power supply 40, and a judgment unit 30 connecting to the primary power supply 10 and the switch unit 20. The primary power supply 10 outputs a start signal V1 at a start status that is transferred through the switch unit 20 to the secondary power supply 40 so that the secondary power supply 40 is driven by the start signal V1 and starts concurrently with the primary power supply 10. The switch unit 20 also transfers the power of the primary power supply 10 to the electronic device 50 in a first power supply status. The judgment unit 30 has a delay time reference value, and gets the start signal V1 and outputs a switch signal S1 to the switch unit 20 after a delay time period according to the delay time reference value to switch power supply status of the electronic device 50. Thereby the electronic device 50 gets the power from the secondary power supply 40 in a second power supply status. Thus the electronic device 50 can continuously get the power from either the primary power supply 10 or the secondary power supply 40 after the primary power supply 10 is started. Referring to FIG. 2, the judgment unit 30 includes a timer circuit 31 to set the delay time reference value and output a set-on power V3 and a judgment switch 32 to receive the set-on power V3 to determine sending the switch signal S1. The switch unit 20 includes a trigger circuit 22 which is electrically connected to the primary power supply 10 to set a base power V2 and get the switch signal S1 and output a trigger signal S2, and a switch 21 to receive the trigger signal S2 and determine turn-on or turn-off thereof.

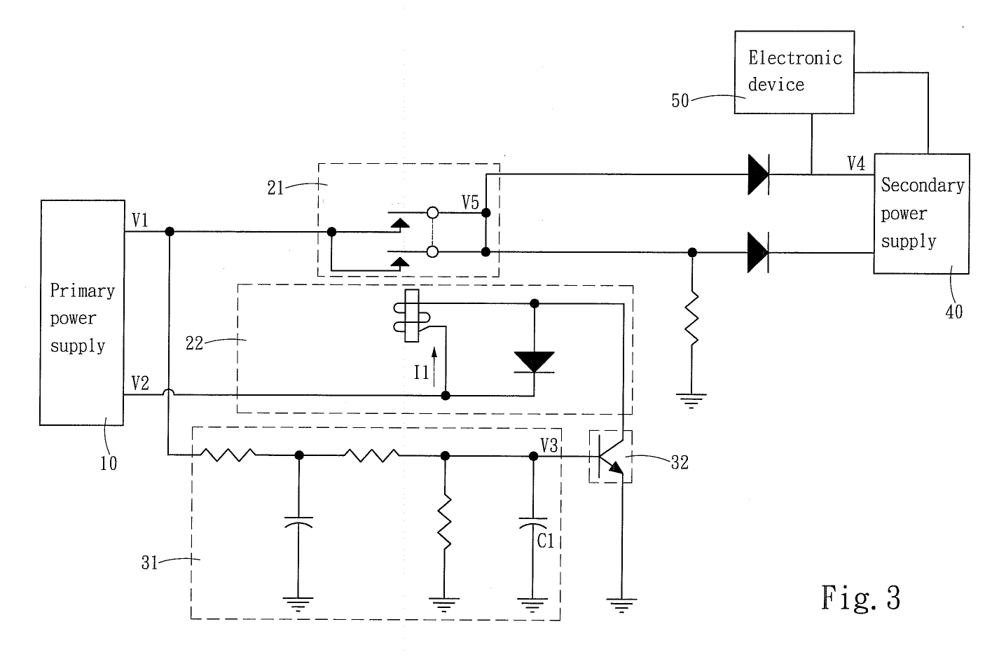

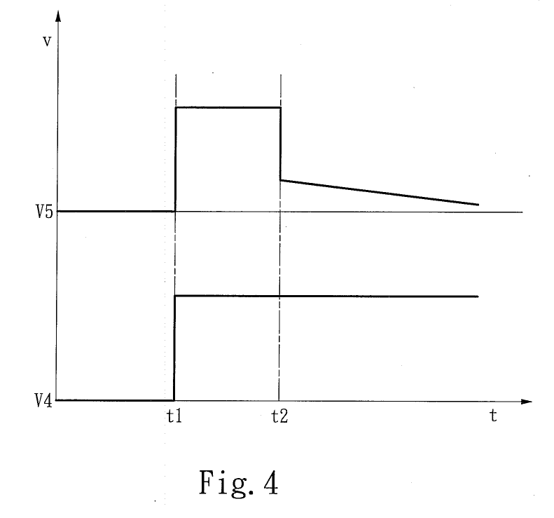

The switch unit 20 is a normally-closed relay. Referring to FIGS. 3 and 4, when the primary power supply 10 is started at time t1, the start signal V1 is output and transferred by the switch 21 of the switch unit 20 to the secondary power supply 40 so that the secondary power supply 40 starts concurrently with the primary power supply 10, and the potential rises at V4. Meanwhile, the primary power supply 10 transfers power to the electronic device 50 to present a first power supply status. At the same time the start signal V1 is transmitted to the timer circuit 31 of the judgment unit 30 to charge a capacitor C1. When the capacitor C1 is charged for a time period t2 and reaches a preset value (a power value to set on the judgment switch 32), the set-on power V3 is provided to set on the judgment switch 32. At that moment the trigger circuit 22 gets the base power V2 output from the primary power supply 10 and generates a current I1, namely the judgment switch 32 outputs the switch signal S1 to the trigger circuit 22. The current I1 flows a coil to induce a magnetic field and trigger and disconnect circuit of the switch 21, and the primary power supply 10 and the secondary power supply 40 are disconnected. Hence the potential of the switch 21 at the potential V5 gradually drops due to stopping supplying of the power from the primary power supply 10. Therefore the electronic device 50 turns to the secondary power supply 40 to get the electric power and present a second power supply status.

The control structure of the invention first makes the primary power supply 10 to provide power to the electronic device 50 at the start time and concurrently activates the secondary power supply 40. When the secondary power supply 40 starts, the power is transferred to the electronic device 50. Through the switch unit 20 the second power supply 40, electronic device 50 and primary power supply 10 are set on so that the electronic device 50 is driven by the secondary power supply 40. Thus after the primary power supply 10 is started the electronic device 50 can continuously receive electric power without the problem of being unable to detect the electronic device 50 by the computer system that might otherwise occur under a circumstance where the primary power supply 10 and the secondary power supply 40 are not started concurrently. It also resolves the disadvantage of the conventional technique of synchronous start of the power supply cluster that requires an additional 24PIN transmission line.

As a conclusion, the invention provides many benefits over the conventional techniques, notably:

1. The electronic device driven by the primary power supply and the electronic device driven by the secondary power supply can be matched closely.

2. Wiring in the computer host is simplified. Cooling efficiency of the electronic device in the computer host also improves.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A control structure for a power supply cluster which includes a primary power supply and a secondary power supply that are independently linked to AC power and transform the AC power to DC power to provide respectively electric power required by an electronic device in a computer system to present respectively a first power supply status and a second power supply status, the control structure comprising:
a switch unit which is linked to the primary power supply and the secondary power supply and gets a start signal from the primary power supply that is transferred to the secondary power supply, and also transfers the electric power of the primary power supply to the electronic device to present the first power supply status; and
a judgment unit which is connected to the primary power supply and the switch unit and has a delay time reference value, and gets the start signal from the primary power supply and defers sending a switch signal to the switch unit according to the delay time reference value so that the electronic device gets the electric power output from the secondary power supply to present the second power supply status.

2. The control structure of claim 1, wherein the judgment unit includes a timer circuit to set the delay time reference value and output a set-on power, and a judgment switch to receive the set-on power to determine sending the switch signal.

3. The control structure of claim 2, wherein the switch unit includes a trigger circuit to set a base power and get the switch signal to output a trigger signal, and a switch to receive the trigger signal to determine turn-on or turn-off thereof.

4. The control structure of claim 3, wherein the trigger circuit is electrically connected to the primary power supply to get the base power.

5. The control structure of claim 1, wherein the switch unit is a normally-closed relay.
